(19) United States
(12) Patent Application Publication
(10) Pub. No.: US 2007/0119100 A1
(43) Pub. Date: May 31, 2007

(54) Panel member control system

(75) Inventors: Masao Nakada, Kosai-city (JP); Daisuke Mukai, Hamamatsu-city (JP); Hiroyuki Furukoshi, Toyohashi-city (JP)

Correspondence Address: POSZ LAW GROUP, PLC, 12040 SOUTH LAKES DRIVE, SUITE 101, RESTON, VA, 20191, US

(73) Assignee: ASMO CO., LTD., Kosai-city (JP)

(21) Appl. No.: 11/604,771

(22) Filed: Nov. 28, 2006

(30) Foreign Application Priority Data
Nov. 28, 2005 (JP) 2005-342727

(51) Int. Cl. E05F 11/44

(52) U.S. Cl. 49/350

(57) ABSTRACT

A control apparatus drives a motor to move a window glass to an opening end locking position beyond a preset stop position and thereby to forcefully stop the window glass at the opening end locking position when the control apparatus senses that an operational switch is continuously operated by a user for a predetermined time period or longer to perform the opening operation of the window glass based on an operational command signal outputted from the operational switch. The control apparatus then resets the preset stop position based on an actual stop position of the window glass at the opening end locking position in a preset stop position resetting operation.

### CROSS REFERENCE TO RELATED APPLICATION

This application is based on and incorporates herein by reference Japanese Patent Application No. 2005-342727 filed on Nov. 28, 2005.

### BACKGROUND OF THE INVENTION

1. Field of the Invention

The present invention relates to a panel member control system.

2. Description of Related Art

In a previously proposed window glass lifting system (a panel member control system), a rotational drive force, which is generated from an electric motor, is transmitted to a lifting mechanism to raise or lower a window glass of a vehicle's door. According to one technique, when the motor of the lifting system is driven to lower the window glass, the window glass is stopped before the window glass reaches a lower end locking position (a mechanical stop position).

Specifically, when the window glass is lowered to the lower end locking position, which is the lower end moving limit of the window glass, the window glass is mechanically restrained by a stopper. At that time, an excessively large impact is applied to the drive system to deteriorate a durability of the drive system, and an unpleasant impact sound is generated. Thus, in order to avoid the above inconveniences, the current position of the window glass is accurately monitored, and the window glass is stopped before the window glass reaches the lower end locking position (see, for example, Japanese Utility Model Registration No. 2277092).

Also, some window glass lifting systems have a pinch sensing function to sense pinching of an external object (e.g., a hand of a vehicle occupant) by the window glass. In the lifting systems having the pinch sensing function, a pinch sensing operation ceasing range is provided below the fully closed position of the window glass. In the pinch sensing operation ceasing range, the sensing operation for sensing the pinching of the object is ceased to limit an erroneous sensing of the pinching.

Specifically, at the location adjacent to the fully dosed position of the window glass, the moving speed of the window glass in the closing direction (upward direction) is reduced due to a slide resistance between the window glass and a weather strip or the like of the door. Thus, in order to limit erroneous sensing of this speed reduction as the occurrence of the pinching of the object, the pinch sensing operation ceasing range is provided on the lower side of the fully closed position.

Thus, also, in these lifting systems having the pinch sensing function, it is important to accurately identify the current position of the window glass at the time of driving the window glass.

Although it is important to accurately identify the current position of the window glass in the lifting systems, the memorized positions, such as the full open position, the fully closed position and the any other position(s), may deviate from the corresponding actual positions due to aging of the system. When this happens, a relative positional deviation may possibly occur between the actual current position of the window glass and the sensed position of the window glass.

The above inconvenience may be addressed as follows. That is, when it is determined that the window glass is stopped in a predetermined range before the fully closed position or the full open position, the movement of the window glass is kept in the same direction as before to further move the window glass to the fully closed position or the full open position in order to reset the fully closed position or the full open position. Upon reaching of the window glass to the fully closed position or the full open position, the window glass is stopped, and the fully closed position or the full open position is reset (see, for example, Japanese Unexamined Patent Publication No. H07-166761).

However, in the case of the technique recited in Japanese Unexamined Patent Publication No. H07-166761, the window glass cannot be stopped in a position, which is inside the pinch sensing operation ceasing range and at which the window glass still leaves a small remaining open space in the window opening of the door. Furthermore, according to the technique recited in Japanese Unexamined Patent Publication No. H07-166761, every time the window glass is raised or lowered, the resetting operation for resetting the fully closed position or the full open position is performed. Thus, the resetting operation is performed even when the resetting operation needs not be performed. Therefore, the electric power consumption is unnecessarily increased.

### SUMMARY OF THE INVENTION

The present invention addresses the above disadvantages. Thus, it is an objective of the present invention to provide a panel member control system that enables appropriate resetting of a moving range of a panel member, which is driven to open and dose its associated opening, through a relatively easy operation.

To achieve the objective of the present invention, there is provided a panel member control system for controlling a panel member that is driven in an opening direction to open an opening of an opening defining member and is driven in a closing direction to dose the opening of the opening defining member. The panel member control system includes a driving means, a position sensing means, an operating means and a controlling means. The driving means is for driving the panel member. The position sensing means is for sensing a position of the panel member. The operating means is for outputting an operational command signal to drive the panel member through the driving means in the opening direction or the closing direction based on an operation performed by a user on the operating means. The controlling means is for controlling the driving means based on both of the operation signal, which is received from the operating means, and the sensed position of the panel member, which is sensed by the position sensing means. The controlling means normally stops the driving means to stop the panel member at a preset stop position, which is placed on an opening center side of an opening end locking position, in an opening operation of the panel member. The controlling means drives the driving means to move the panel member to the opening end locking position beyond the preset stop position and thereby to forcefully stop the panel member at the opening end locking position and resets the preset stop position based on an actual stop position of the panel member at the opening end locking position in a preset stop position resetting operation when the controlling means senses that the operating means is continuously operated by the user for a predetermined time period or longer to perform the opening operation of the panel member based on the operational command signal.

### BRIEF DESCRIPTION OF THE DRAWINGS

The invention, together with additional objectives, features and advantages thereof, will be best understood from the following description, the appended claims and the accompanying drawings in which:

FIG. 1 is a descriptive view of a power window system according to an embodiment of the present invention;

FIG. 2 is a diagram showing an electrical structure of the power window system shown in FIG. 1;

FIG. 3A is a diagram showing an electrical structure of an operational switch of the power window system;

FIG. 3B is diagram showing a modification of the electrical structure of the operational switch shown in FIG. 3A;

FIG. 4 is a descriptive diagram showing a relationship between preset positions and pulse count values;

FIG. 5 is a flowchart showing a part of a window control operation executed by a controller of the power window system;

FIG. 6 is a flowchart showing another part of the window control operation executed by the controller of the power window system; and

FIG. 7 is a flowchart showing a window position control operation executed by the controller of the power window system.

### DETAILED DESCRIPTION OF THE INVENTION

An embodiment of the present invention will be described with reference to the accompanying drawings. The following structure and operational sequences are not intended to limit the scope of the present invention and can be modified in various ways within the scope of the present invention.

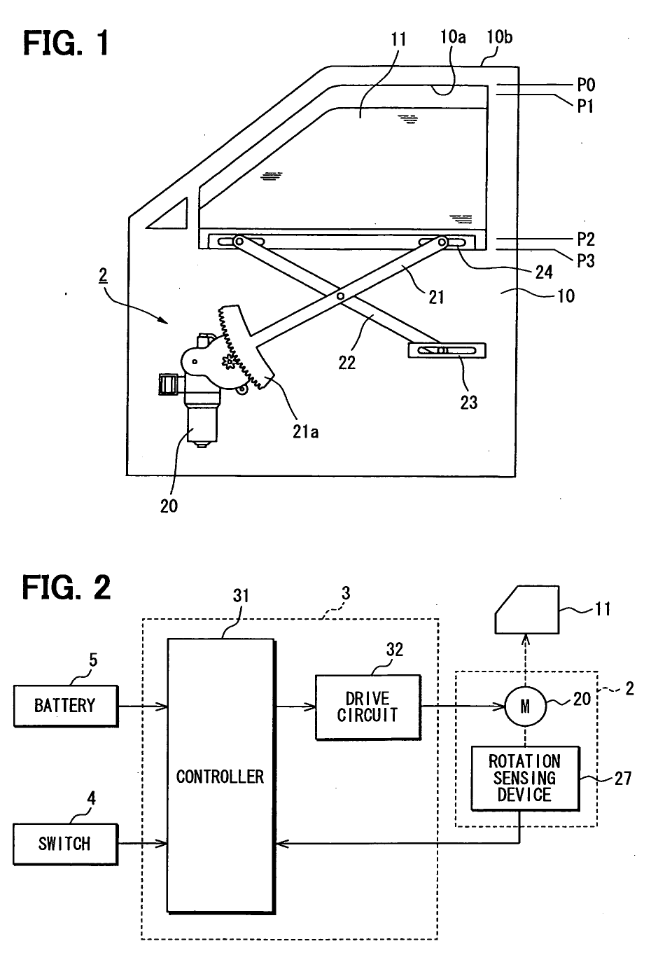

FIG. 1 is a descriptive view of a power window system 1 (hereinafter, simply referred to as a system 1), in which a panel member control system of the present invention is implemented. FIG. 2 is an electrical structural diagram of the power window system 1. In the power window system 1 of the present embodiment, a motor 20 is driven to lower and raise (open and close) a window glass 11, which is arranged in a door (an opening defining member) 10 of a vehicle and serves as a panel member of the present invention. The system 1 includes a driving apparatus (a driving means) 2, a control apparatus (a controlling means) 3 and an operational switch 4. The driving apparatus 2 is for driving the window glass 11 to lower and raise the window glass 11 and thereby to open and close an window opening 10a, which is defined by a window frame 10b of the door 10. The control apparatus 3 is for controlling an operation of the driving apparatus 2. The operational switch 4 serves as an operating means for receiving an operational command from an occupant of the vehicle.

In the present embodiment, the window glass 11 is guided by a rail (not shown) such that an upper end of the window glass 11 is moved between an upper fully closed position (a closing end locking position) P0 and a lower full open position (an opening end locking position) P3. The fully closed position P0 and the full open position P3 are an upper moving limit and a lower moving limit, respectively, of the window glass 11, at which the further raising movement and the further lowering movement of the window glass 11 are respectively limited.

Here, it should be noted that the fully closed position P0 and the full open position P3 may slightly change due to, for example, aging in some cases. For example, the upper and lower moving limits of the window glass 11 may slightly change due to a change in an engaged state between the window glass 11 and a weather strip provided to the window frame 10b of the door 10 in some cases.

In the present embodiment, the window glass 11 is controlled to stop at a preset stop position P2 at the time of fully opening the window glass 11. The preset stop position P2 is located on a fully closed position P0 side (an opening center side where a vertical center or a window glass travel path center in the opening 10a is located) of the full open position P3. With this construction, at the time of lowering the window glass 11, it is possible to limit occurrence of abutment of the window glass 11 to a member of the drive system at the lower end position of the window glass 11, and thereby it is possible to limit generation of an impact sound, which normally occurs upon the abutment of the window glass 11 to the member of the drive system.

Thus, in the present embodiment, the window glass 11 is normally raised and lowered between the fully closed position P0 and the preset stop position P2 during the normal operation time.

The control apparatus 3 includes a pinch sensing function (a pinch sensing means) for sensing pinching of an external object between an upper end edge of the window glass 11 and the window frame 10b based on an amount of change in the moving speed of the window glass 11 at the time of closing the window glass 11. When the pinching of the object is sensed, the control apparatus 3 reverses the raising operation of the driving apparatus 2 to lower the window glass 11 to release the pinched object.

A slide resistance, which is applied to the window glass 11 from, for example, the weather strip (not shown), is increased at or around the fully dosed position P0. Thus, the moving speed of the window glass 11 is reduced. In view of this point, in the system 1 of the present embodiment, a pinch sensing operation ceasing range is provided around the fully closed position P0. In the pinch sensing operation ceasing range, the pinch sensing operation for sensing the pinching of the object is ceased to limit erroneous sensing of the speed reduction of the window glass 11 as the pinching of the object by the window glass 11.

Specifically, in the system 1 of the present embodiment, a pinch sensing operation ceasing position P1 is set on a full open position P3 side (opening center side) of the fully closed position P0. When the window glass 11 is in the range (the pinch sensing operation ceasing range) between the sensing operation ceasing position P1 and the fully closed position P0, the pinch sensing operation is not performed in the system 1.

The driving apparatus 2 of the present embodiment includes the motor 20, a lifting arm 21, a driven-side arm 22, a stationary channel 23 and glass-side channels 24. The motor 20 is fixed to the door 10 and includes a speed reducing mechanism. The lifting arm 21 includes a fan-shaped gear 21a, which is driven by the motor 20. The driven-side arm 22 is connected with the lifting arm 21 in a crisscross like fashion and is pivotably supported. The stationary channel 23 is fixed to the door 10. The glass-side channels 24 are integral with the window glass 11.

When the control apparatus 3 supplies the electric power to the motor 20, a winding of a rotor of the motor 20 is energized, so that a magnetic attractive action occurs between the rotor and a stator having magnets in the motor 20. In the driving apparatus 2, when the motor 20 is driven, the lifting arm 21 and the driven-side arm 22 are swung. At this time, movement of corresponding ends of the lifting arm 21 and of the driven-side arm 22 are limited by the channels 23, 24, so that the lifting arm 21 and the driven-side arm 22 function as an X-linkage to raise or lower the window glass 11.

A rotation sensing device 27 is integrally provided in the motor 20. The rotation sensing device 27 outputs a pulse signal (a rotational speed signal), which is synchronized with the rotation of the motor 20, to the control apparatus 3. The rotation sensing device 27 includes a plurality of Hall elements to sense a change in magnetism of a magnet, which rotates integrally with an output shaft of the motor 20. Specifically, the pulse signal is outputted from the rotation sensing device 27 at every predetermined moving amount of the window glass 11 or at every predetermined rotational angle of the motor 20. In this way, the rotation sensing device 27 can output the signal that corresponds to the movement of the window glass 11, which is generally proportional to the rotational speed of the motor 20. The control apparatus 3 senses, i.e., determines the position of the window glass 11 based on the pulse signal transmitted from the rotation sensing device 27. In the present embodiment, the rotation sensing device 27 and the control apparatus 3 constitute a position sensing means of the present invention.

In the present embodiment, although the Hall elements are used in the rotation sensing device 27, an encoder may be alternatively used as long as it can sense the rotational speed of the motor 20. Furthermore, in the present embodiment, the rotation sensing device 27 is provided integrally in the motor 20 to sense the rotation of the output shaft of the motor 20, which corresponds to the movement of the window glass 11. However, the present invention is not limited to this. Specifically, any known appropriate means or any known appropriate device may be alternatively used to directly sense the position of the window glass 11.

The control apparatus 3 of the present embodiment includes a controller 31 and a drive circuit 32. The controller 31 and the drive circuit 32 receive required electric power form a battery 5 of the vehicle.

The controller 31 includes a microcomputer, which has a CPU, memories (e.g., a ROM, a RAM), an input circuit, an output circuit and the like. The CPU is interconnected with the memories, the input circuit and the output circuit through a bus. The structure of the controller 31 is not limited to the above one. For example, the controller 31 may be constructed from a logic IC(s), a DSP(s), a gate allay(s) and/or a transistor(s).

The controller 31 drives the motor 20 in a normal direction or a reverse direction through the drive circuit 32 based on the operational signal (operational command signal), which is transmitted from the operational switch 4 to lower or raise the window glass 11 and thereby to open or close the opening 10a of the door 10. Furthermore, the controller 31 senses the position of the window glass 11 based on the pulse signal received from the rotation sensing device 27 to adjust the drive electric power, which is supplied to the motor 20 through the drive circuit 32 according to the sensed position of the window glass 11. Specifically, the controller 31 adjusts the drive voltage or a duty ratio in a case of performing a PWM control operation. In this way, the controller 31 adjusts the motor output power.

The drive circuit 32 includes an IC, which has FETs. The drive circuit 32 switches a polarity of the electric current supplied to the motor 20 based on a control signal received from the controller 31. Specifically, when the drive circuit 32 receives a normal rotation command from the controller 31, the drive circuit 32 supplies the electric power to the motor 20 in a manner that causes the rotation of the motor 20 in the normal rotational direction. In contrast, when the drive circuit 32 receives a reverse rotation command from the controller 31, the drive circuit 32 supplies the electric power to the motor 20 in a manner that causes the rotation of the motor 20 in the reverse rotational direction. Alternative to the FETs, the drive circuit 32 may include a relay circuit to change the polarity. Furthermore, the drive circuit 32 may be integrated in the controller 31 in some cases.

The controller 31 senses a leading edge and a trailing edge of the supplied pulse signal (pulse edges). Then, the controller 31 computes the rotational speed (a rotational cycle) of the motor 20 based on an interval between the pulse edges and also senses the rotational direction of the motor 20 based on a phase difference between the pulse signals. That is, the controller 31 computes the moving speed of the window glass 11 based on the rotational speed (the rotational cycle) of the motor 20 and determines the moving direction of the window glass 11 based on the rotational direction of the motor 20. Furthermore, the controller 31 counts the pulse edges. This pulse count value N is incremented or decremented in response to the opening or closing movement of the window glass 11. The controller 31 determines the position of the window glass 11 based on the pulse count value N.

Specifically, in the present embodiment, the fully closed position P0 is set as a reference position, and therefore the pulse count value N at the fully closed position P0 is set as zero (0). When the window glass 11 is moving toward the full open position P3, the controller 31 increments the pulse count value N by one (1) every time the pulse signal is received. In contrast, when the window glass 11 is moving toward the fully closed position P0, the controller 31 decrements the pulse count value N by one (1) every time the pulse signal is received.

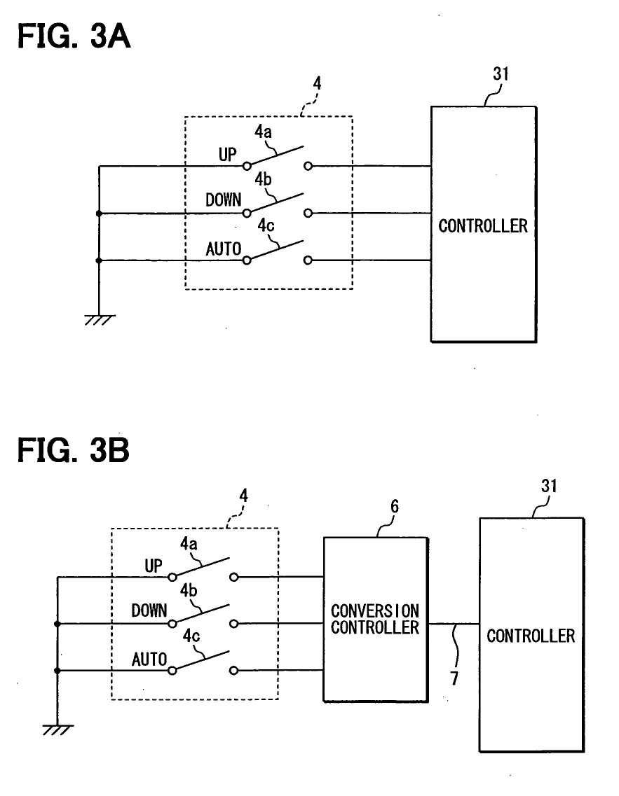

FIG. 3A indicates the electrical structure of the operational switch 4. In the present embodiment, the operational switch 4 is implemented as a rocker switch, which is operable in two steps and includes an up switch (closing switch) 4a, a down switch 4b (opening switch) and an automatic switch 4c. One electrical contact of each of these switches 4a-4c is connected to a corresponding terminal of the controller 31, and another electrical contact of each of these switches 4a-4c is grounded to a vehicle body. When the vehicle occupant operates the operational switch 4, the command signal, which commands the opening or closing of the window glass 11, is outputted from the operational switch 4 to the controller 31. In the present embodiment, when the operational switch 4 is operated, i.e., depressed or pulled one step, a manual operation is performed. In contrast, when the operational switch 4 is operated, two steps, an automatic operation is performed.

Specifically, when one end of the operational switch 4 is operated, i.e., depressed or pulled one step to an up position, the up switch 4a is switched on, and thereby the electric potential of the corresponding terminal of the controller 31, to which the up switch 4a is connected, is reduced. The controller 31 recognizes this electric potential drop as a normal closing command signal (a manual operational signal) for performing a normal closing operation of the window glass 11 (an operation for closing, i.e., raising the window glass 11 only through a period of operating the up switch 4a). Throughout the period of receiving the normal closing command signal from the operational switch 4, the controller 31 sets, i.e., turns on a closing operational flag, so that the controller 31 controls the drive circuit 32 based on the dosing operational flag.

Furthermore, when the other end of the operational switch 4 is operated, i.e., depressed or pulled one step to a down position, the down switch 4b is switched on. Thereby, the electrical potential of the corresponding terminal of the controller 31, to which the down switch 4b is connected, is reduced. The controller 31 recognizes this electric potential drop as a normal opening command signal (a manual operational signal) for performing a normal opening operation of the window glass 11 (an operation for opening, i.e., lowering the window glass 11 only through a period of operating the down switch 4b).

Furthermore, when the one end of the operational switch 4 is operated, i.e., depressed or pulled two steps to an automatic up (also referred to as “ auto-up”) position, the up switch 4a and the automatic switch 4c are both switched on. Thereby, the electrical potentials of the corresponding terminals of the controller 31, to which the up switch 4a and the automatic switch 4c are respectively connected, are reduced. The controller 31 recognizes these electric potential drops as an automatic closing command signal (an automatic operational signal) for performing an automatic closing operation (an operation for closing, i.e., raising the window glass 11 all the way to the fully closed position P0 even if the operation of the one end of the operational switch 4 is stopped in the middle).

Furthermore, when the other end of the operational switch 4 is operated, i.e., depressed or pulled two steps to an automatic down (also referred to as “auto-down”) position, the down switch 4b and the automatic switch 4c are both switched on. Thereby, the electrical potentials of the corresponding terminals of the controller 31, to which the down switch 4b and the automatic switch 4c are respectively connected, are reduced. The controller 31 recognizes these electric potential drops as an automatic opening command signal (an automatic operational signal) for performing an automatic opening operation (an operation for opening, i.e., lowering the window glass 11 all the way to the preset stop position P2 even if the operation of the other end of the operational switch 4 is stopped in the middle).

Throughout the period of receiving the normal opening command signal from the operational switch 4 (the period of operating the operational switch 4), the controller 31 drives the motor 20 through the controller 31 to perform the normal opening operation of the window glass 11. In contrast, throughout the period of receiving the normal closing command signal from the operational switch 4 (the period of operating the operational switch 4), the controller 31 drives the motor 20 through the controller 31 to perform the normal closing operation of the window glass 11.

The controller 31 sets an opening operational flag (used in a manner similar to that of the closing operational flag, but in the normal opening operation) and the closing operational flag during the period of receiving the normal opening command signal and the period of receiving the normal closing command signal, respectively, so that the controller 31 controls the drive circuit 32 based on these flags.

Furthermore, when the controller 31 receives the automatic opening command signal from the operational switch 4, the controller 31 drives the motor 20 through the drive circuit 32 to perform the automatic opening operation of the window glass 11, so that the window glass 11 is lowered to the preset stop position P2. In contrast, when the controller 31 receives the automatic closing command signal from the operational switch 4, the controller 31 drives the motor 20 through the drive circuit 32 to perform the automatic closing operation of the window glass 11, so that the window glass 11 is raised to the fully closed position P0.

When the controller 31 receives the automatic opening command signal or the automatic closing command signal, the opening operational flag or the closing operational flag is set, i.e., is turned on, so that the controller 31 controls the drive circuit 32 based on these flags. Each of these flags is reset, i.e., is turned off under a predetermined condition to stop the driving of the window glass 11.

In the exemplary case shown in FIG. 3A, the one electrical contact of the up switch 4a, the one electrical contact of the down switch 4b and the one electrical contact of the automatic switch 4c are all directly connected to the terminals, respectively, of the controller 31. However, the present invention is not limited to this construction. For instance, this construction may be replaced with a construction shown in FIG. 3B.

In the exemplary case of FIG. 3B, the one electrical contact of the up switch 4a, the one electrical contact of the down switch 4b and the one electrical contact of the automatic switch 4c are all connected to a network conversion controller 6. The network conversion controller 6 is connected to the controller 31 through a network line 7.

In this construction, upon turning on of one of the up switch 4a and the down switch 4b and/or the automatic switch 4c to ground each corresponding switch 4a-c, this grounding state is notified to the network conversion controller 6 and then to the controller 31 through the network line 7. In this way, the number of connecting lines can be reduced to allow weight reduction of the vehicle.

Next, the movement of the window glass 11 in the system 1 will be described.

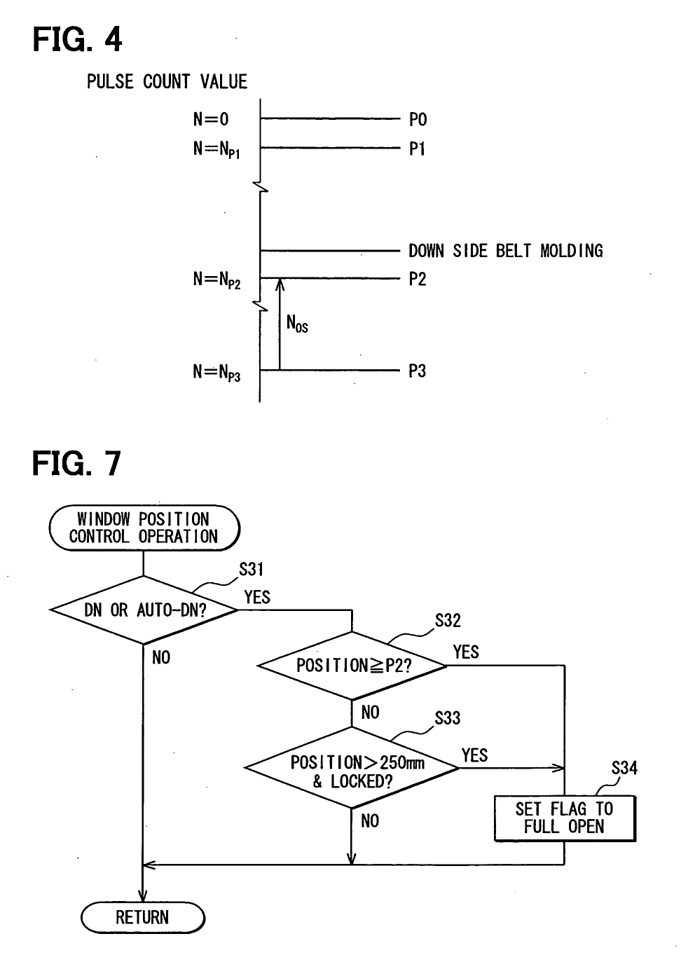

With reference to FIG. 4, in an Initial state, the controller 31 initially stores the pulse count value N of the fully closed position P0 as zero (0), the pulse count value N of the sensing operation ceasing position P1 as N_{P1}, the pulse count value N of the preset stop position P2 as N_{P2} and the pulse count value N of the full open position P3 as N_{P3} in the memory of the controller 31. The controller 31 compares the pulse count value N, which is incremented or decremented in response to the lowering or raising of the window glass 11, with the above stored values, which are stored in the memory of the controller 31, to determine the current position of the window glass 11 and to control the movement of the window glass 11.

In the present embodiment, when the normal opening command signal or the automatic opening command signal is received continuously from the operational switch 4, the controller 31 supplies the drive voltage continuously to drive the motor 20 in the direction for moving the window glass 11 toward the full open position P3. In contrast, when the normal closing command signal or the automatic closing command signal is received continuously from the operational switch 4, the controller 31 supplies the drive voltage continuously to drive the motor 20 in the direction for moving the window glass 11 toward the fully closed position P0. In this way, the motor 20 drives the window glass 11 to lower or raise the window glass 11 through the drive mechanism of the driving apparatus 2.

In the present embodiment, the fully closed position P0 and the full open position P3 are mechanically locking positions, at which further movement of the window glass 11 is forcefully stopped. Thus, in the case where a change due to, for example, the aging of the system 1 does not exist, as long as no object is pinched by the window glass 11, the window glass 11 reaches the fully closed position P0 and is thereby locked when the pulse count value N reaches zero (0) at the time of moving the window glass 11 in the closing direction.

Alternatively, in the state where the window glass 11 is placed in the locked state without resulting in the pinching of the object, it may be determined that the window glass 11 is stopped at the fully closed position P0, and thereby the pulse count value N may be reset to zero.

As discussed above, the preset stop position P2 is spaced by a predetermined distance from the full open position P3 on the fully closed position P0 side of the full open position P3. Specifically, the preset stop position P2 is offset from the full open position P3 by the predetermined distance, which corresponds to a predetermined pulse count number (the offset count number Nos in the present embodiment), on the fully closed position P0 side of the full open position P3. As shown in FIG. 4, in the present embodiment, the preset stop position P2 is on the lower side of a down side belt molding position (a position where a down side belt molding of the door 10 is located).

The sensing operation ceasing position P1 is spaced from each of the full open position P3 and the fully closed position P0 by the corresponding distance, which corresponds to a corresponding predetermined pulse count number.

In the system 1 of the present embodiment, the preset stop position P2, the full open position P3 and the sensing operation ceasing position P1 can be reset, i.e., can be rearranged by the occupant through manipulation of the operational switch 4. As the normal operation of the operational switch 4, the occupant may hold the manipulation switch 4 at the down position or at the automatic down position to lower the window glass 11 to the preset stop position P2.

The lowest possible position of the window glass 11, which can be achieved through this normal operation of the operational switch 4, is the currently memorized preset stop position P2.

As described above, the preset stop position P2 or the full open position P3 may possibly be deviated from its actual position due to the aging or the like.

In such a case, while the window glass 11 is placed in the preset stop position P2, the occupant may further operate the operational switch 4 to hold the operational switch 4 at the automatic down position for a predetermined time period (3 seconds in the present embodiment). At this time, the controller 31 counts a duration time period of the voltage drop at the terminals of the controller 31, to which the down switch 4b and the automatic switch 4c are connected, to determine whether the operational switch 4 is held in the automatic down position for the predetermined time period or longer.

In this way, the system 1 starts a resetting process (a preset stop position resetting process). When this resetting process is initiated, the controller 31 drives the motor 20 to move the window glass 11 toward the full open position P3 regardless of the memorized pulse count value NP3 of the full open position P3, which is stored in the memory of the controller 31, until the movement of the window glass 11 is limited at the full open position P3.

The locked position of the window glass 11 is the actual full open position P3 at that time point, and thereby the pulse count value N of this time point is now set as the pulse count value N_{P3} of the full open position P3.

Furthermore, the value, which is obtained by subtracting the offset count number Nos from the new pulse count value N_{P3}, is set by the controller 31 as the new pulse count value N_{P2} of the preset stop position P2.

Also, the controller 31 resets the pulse count value N_{P1} of the sensing operation ceasing position P1 based the new pulse count value N_{P3}. The resetting of the pulse count value N_{P1} can be alternatively performed by using the fully closed position P0 as a reference position. For example, the controller 31 may add an offset count value to the pulse count value N, which is measured at the time of locking of the window glass 11 upon the closing movement of the window glass 11 toward the fully closed position without pinching of any object. Then, the controller 31 may set this resultant count value as the new pulse count value N_{P1} of the sensing operation ceasing position P1.

As described above, according to the present embodiment, the occupant can easily perform the resetting process of the full open position P3 and of the preset stop position P2 in the manner similar to the normal operation of the operational switch 4.

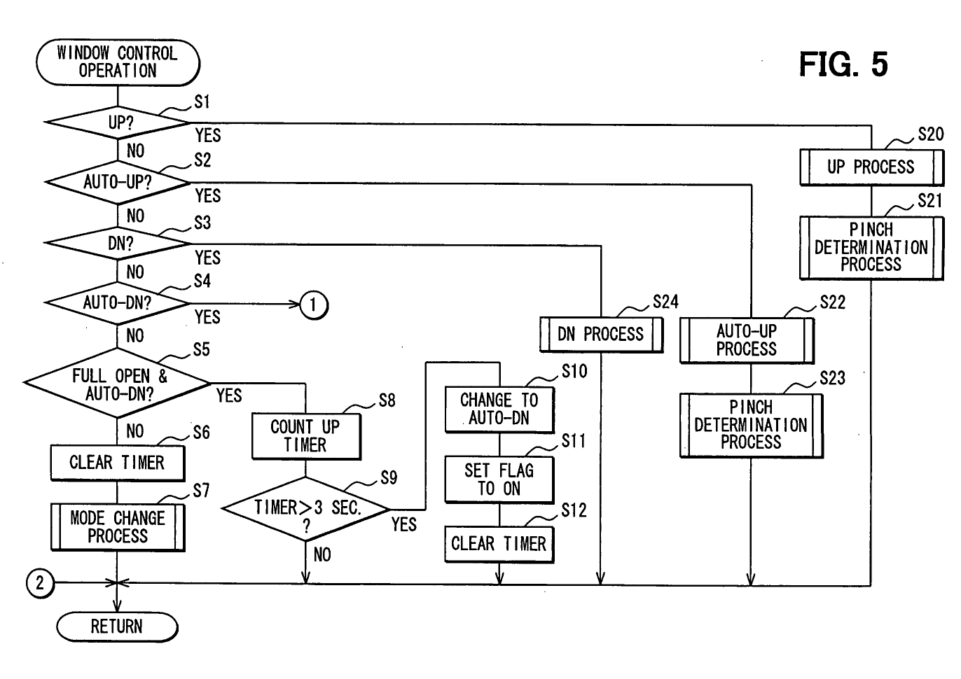

Next, an operational flow of the controller 31 will be described with reference to FIGS. 5 to 7.

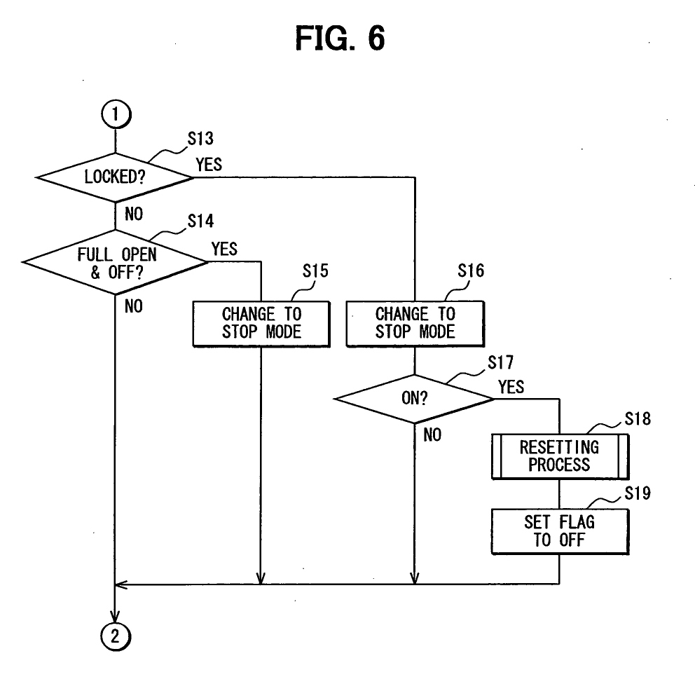

First, the window control operation of the controller 31 will be described with reference to FIGS. 5 and 6. This operation is repeated at predetermined time intervals.

The controller 31 renews and stores the current operational mode (an up mode, an automatic up mode, a down mode, an automatic down mode or a stop mode) in the memory to raise or lower the window glass 11. In principle, this operational mode is changed according to the operation of the operational switch 4, as will be discussed below.

According to the present embodiment, when it is determined that the operational switch 4 is placed in the up position or the down position in view of the closing operational flag or the opening operational flag, the operational mode is changed to and is stored as the up mode or the down mode only through the period of operating the operational switch 4. However, when it is determined that the operational switch 4 is placed in the automatic up position or the automatic down position, the operational mode is latched to and is stored as the automatic up mode or the automatic down mode. Then, the controller 31 performs the corresponding operation based on each corresponding operational mode.

In the window control operation, it is first determined whether the operational mode, which is currently stored in the memory, is the up mode (step S1).

When it is determined that the current operational mode is the up mode (i.e. Yes at step S1), the controller 31 performs a closing process, which is also referred to as “an up process” (step S20). Specifically, at step S20, the controller 31 drives the motor 20 in the direction (closing direction) for raising the window glass 11, and the controller 31 also performs a pinch determination (sensing) process for determining (sensing) whether an object is pinched by the window glass 11 at step S21.

As described above, in the case where the current operational mode is the up mode, steps S1, S20 and S21 are repeated. Furthermore, when it is determined that the object is not pinched by the window glass 11 at step S21, the window glass 11 is driven to the fully closed position P0 and is stopped. When the window glass 11 is stopped, the operational mode is renewed to the stop mode. When it is determined that the object is pinched by the window glass 11 in the pinch determination process at step S21, the controller 31 reverses the rotation of the motor 20 to lower the window glass 11 and thereby to release the pinched object.

Returning to step S1, when it is determined that the current operational mode is not the up mode (i.e., No at step S1), it is then determined whether the current operational mode is the automatic up mode at step S2.

When it is determined that the current operational mode is the automatic up mode (i.e., Yes at step S2), the controller 31 performs an automatic closing (also referred to as “auto-closing” or “auto-up”) process at step S22. Specifically, at step S22, the controller 31 drives the motor 20 in the direction (closing direction) for raising the window glass 11 through the drive circuit 32 to place the window glass 11 in the fully closed position P0, and the controller 31 also performs the pinch determination (sensing) process for determining (sensing) whether the object is pinched by the window glass 11 at step S23.

As described above, in the case where the current operational mode is the automatic up mode, steps S1, S2, S22 and S23 are repeated. Furthermore, when it is determined that the object is not pinched by the window glass 11 at step S23, the window glass 11 is driven to the fully closed position P0 and is stopped. When the window glass 11 is stopped, the operational mode is renewed to the stop mode. When it is determined that the object is pinched by the window glass 11 in the pinch determination process at step 523, the controller 31 reverses the rotation of the motor 20 to lower the window glass 11 and thereby to release the pinched object.

Returning to step S2, when it is determined that the current operational mode is not the automatic up mode (i.e., No at step S2), it is then determined whether the current operational mode is the down (DN) mode at step S3.

When it is determined that the current operational mode is the down mode (i.e., Yes at step S3), the controller 31 performs an opening process, which is also referred to as “a down process” or “an DN process”, at step S24. Specifically, at step 524, the controller 31 drives the motor 20 in the direction (opening direction) for lowering the window glass 11 and thereafter terminates the current operation.

As described above, in the case where the current operational mode is the down mode, steps S1, S2, S3 and S24 are repeated, and the window glass 11 is driven to the preset stop position P2 and is stopped. When the window glass 11 is stopped, the operational mode is renewed to the stop mode.

Returning to step S3, when it is determined that the current operational mode is not the down mode (i.e., No at step S3), it is then determined whether the current operational mode is the automatic down (auto-DN) mode at step S4.

When it is determined that the current operational mode is not the automatic down mode at step 54 (i.e., No at step 54), the controller 31 determines whether a position flag of the window glass 11, which is stored in the memory, is set to a “full open” state and also determines whether the automatic opening (auto-down) command signal is received from the operational switch 4 at step S5.

Now, a position flag setting process (a window position control operation) for setting the position flag of the window glass 11 performed by the controller 31 will be described with reference to FIG. 7. Similar to the window control operation, this process is performed repeatedly.

First, the controller 31 determines whether the current operational mode is the down mode or the automatic down mode at step S31.

When it is determined that the current operational mode is not the down mode or the automatic down mode (i.e., No at step S31), the current process is terminated without setting the position flag to “full open”.

In contrast, when it is determined that the current operational mode is the down mode or the automatic down mode (i.e., Yes at step S31), the controller 31 determines whether the current position of the window glass 11 is equal to or greater than the preset stop position P2 (i.e., whether the current position of the window glass 11 is in the range between the preset stop position P2 and the full open position P3) at step S32.

When it is determined the current position of the window glass 11 is equal to or greater than the preset stop position P2 (i.e., Yes at step S32), the controller 31 sets the position flag to “full open” at step S34.

In contrast, when it is determined that the current position of the window glass 11 is on the fully closed position P0 side of the present stop position P2 at step S32 (i.e., No at step S32), the controller 31 determines whether a distance from the fully closed position P0 to the current position of the window glass 11 is equal to or greater than a predetermined distance (250 mm in the present embodiment) on the full open position P3 side of the fully closed position P0 and also determines whether the locking of the window glass 11 is sensed at step S33.

Specifically, at step S33, it is determined whether the window glass 11 is in the locked state in the normal operational range, which does not include the pinch sensing operation ceasing range.

When it is determined that the window glass 11 is locked in the predetermined range at step S33 (i.e., Yes at step S33), the controller 31 sets the position flag to “full open” at step S34. Therefore, here, even in the case where the window glass 11 has not yet reached the preset stop position P2, when the window glass 11 is locked due to some reason, the position flag is set to “full open”.

In contrast, when the window glass 11 is not locked within the predetermined range (i.e., No at step S33), the current process is terminated without setting the position flag to “full open”.

Returning to FIG. 5, when it is determined that the position flag of the window glass 11 is not set to “full open”, or the automatic opening command signal is not received from the operational switch 4 at step S5 (i.e., No at step S5), the controller 31 clears a automatic down enabling timer at step S6 and proceeds to a process of step S7.

The automatic down enabling timer is a timer used to determine whether the resetting process for resetting the preset stop position P2 (and/or the other positions) with respect to the full open position P3 should be enabled.

At step S7, the controller 31 performs an operational mode changing process. Specifically, at this stage, the current operational mode is the stop mode. In this state, when the controller 31 has already received the normal closing command signal upon changing of the operational switch 4 to the up position, the controller 31 changes the operational mode to the up mode. Similarly, when the controller 31 has already received one of the normal opening command signal, the automatic closing command signal and the automatic opening command signal upon changing of the operational switch 4 to the corresponding one of the down position, the automatic up position and the automatic down position, the controller changes the operational mode to the corresponding one of the down mode, the automatic up mode and the automatic down mode.

For example, in the fully closed state of the window glass 11, in which the operational mode is the stop mode, when the operational switch 4 is placed in the automatic down position, No at step S1, No at step S2, No at step S3, No step S4 and No at step S5 are respectively returned. Thus, the automatic down enabling timer is cleared at step S6, and the operational mode is changed to the automatic down mode at step S7.

After the operational mode is changed from the stop mode to any one of the other remaining modes, corresponding one or more of steps S1-S4 is performed.

When it is determined that the current position of the window glass 11 is in the preset stop position P2, and the automatic opening command signal has been received from the operational switch 4 (i.e., Yes at step S5), the controller 31 performs a process of step S8.

The process of step S8 is performed in the following cases. That is, in one case, the window glass 11 has moved to the memorized present stop position P2, which is currently stored in the memory, so that the operational mode is changed to the stop mode, and then the operational switch 4 is placed to the automatic down position. In another case, the window glass 11 is placed in the full open state, i.e., is stopped in the preset stop position P2, and then the operational switch 4 is placed to the automatic down position.

At step S8, a process for counting up the automatic down enabling timer is performed. Specifically, a time period of continuously holding the operational switch 4 in the automatic down position is counted at step S8. Then, at step S9, it is determined whether the time counted by the automatic down enabling timer has exceeded a predetermined time period (3 seconds in the present embodiment).

When it is determined that the time counted by the automatic down enabling timer has not exceeded the predetermined time period at step S9 (i.e., No at step S9), the controller 31 terminates the current operation without taking any further action. Thus, for example, in the full open state of the window glass 11 in the stop mode, when the operational switch 4 is placed to the automatic down position, steps S1-S5, S7 and S8 are repeated, and the automatic down enabling timer is incremented.

When it is determined that the time counted by the automatic down enabling timer has exceeded the predetermined time period at step S9 (i.e., Yes at step S9), the controller 31 starts a process of moving the window glass 11 in the opening direction (the downward direction). Specifically, the controller 31 changes the current operational mode to the automatic down mode at step S10. Then, the controller 31 sets a resetting flag for resetting the preset stop position P2 to an ON state at step S11. Thereafter, the controller 31 clears the automatic down enabling timer at step S12 and terminates the current operation.

When the resetting flag is set to the ON state, the resetting process for resetting the preset stop position P2 (and/or the other positions) is started.

As described above, according to the present embodiment, in the full open state of the window glass 11, when the automatic down position of the operational switch 4 is maintained for the predetermined time period or longer, the resetting process for resetting the preset stop position P2 is started. Therefore, according to the present embodiment, when the occupant appropriately operates the operational switch 4, the resetting process for resetting the preset stop position P2 can be easily started.

Furthermore, according to the present embodiment, even when the operational switch 4 is erroneously operated, the resetting process for resetting the preset stop position P2 does not start unless the automatic down position of the operational switch 4 is maintained for the predetermined time period or longer. In this way, according to the present embodiment, only when the resetting of the preset stop position P2 is required, the resetting process for resetting the preset stop position P2 is performed. Thus, it is possible to limit the electric power consumption.

Returning to step S4, when it is determined that the current operational mode is the automatic down mode (Yes at step S4), it is sensed whether the window glass 11 is in the locked state at step S13 (FIG. 6). Specifically, when the controller 31 does not continuously receive the pulse signals from the rotation sensing device 27 for the predetermined time period or longer, the controller 31 determines that the rotation of the motor 20 is stopped, and the window glass 11 is in the locked state.

In the automatic down mode, the window glass 11 is moved toward the full open position P3 without pinching the object in the normal situation. Therefore, in the normal situation, the locked state of the window glass 11 occurs when the movement of the window glass 11 is limited at the full open position P3.

In the unlocked state of the window glass 11 (No at step S13), the controller 31 determines whether the position flag of the window glass 11 is set to “full open” and also determines whether the resetting flag is set to an OFF state at step S14.

The position flag and the resetting flag are set to “full open” and “OFF”, respectively, in the unlocked state (i.e., Yes at step S14), for example, in the case where the window glass 11 in the normal operational range has been moved by the automatic opening operation, and thereby the window glass 11 has been reached the preset stop position P2. At this time, the controller 31 changes the operational mode to the stop mode at step S15. In this way, the controller 31 stops the electric power supply to the motor 20, and thereby the window glass 11 is stopped in the preset stop position P2.

In contrast, the position flag and/or the resetting flag are not set to “full open” and/or “OFF”, respectively, in the unlocked state (i.e., No at step S14), for example, in the case where the window glass 11 in the normal operational range is currently moved by the automatic opening operation, or the window glass 11 is currently moved by the automatic opening operation beyond the preset stop position P2 in the ON state of the resetting flag after changing of the operational mode to the automatic down mode at step S10. At this time, the current operation is terminated to continue the automatic opening operation.

When the locked state of the window glass 11 is sensed at step S13 (i.e., Yes at step 513), the window glass 11 has been forcefully stopped upon reaching of the window glass 11 to the full open position P3. Thus, the controller 31 changes the operational mode to the stop mode (step S16). In this way, the electric power supply to the motor 20 is stopped.

Then, the controller 31 determines whether the resetting flag for resetting the preset stop position P2 is set to the ON state at step S17.

The resetting flag for resetting the preset stop position P2 is not set to the ON state (i.e., No at step S17), for example, in the case where the window glass 11 has been locked due to some reason during the operation in the automatic down mode. Thus, the operational mode is kept in the stop mode, and the current operation is terminated. In this way, the motor 20 is kept in the stop state, and thereby the window glass 11 is also kept in the stop state.

In contrast, the resetting flag for resetting the preset stop position P2 is set to the ON state (i.e., Yes at step S17), for example, in the case where the window glass 11 has been stopped in the full open position P3. Thus, the controller 31 performs the resetting process fbr resetting the preset stop position P2 at step S18 and sets the resetting flag to the OFF state at step S19.

Specifically, in the resetting process, the controller 31 resets the pulse count value N_{P3} as the pulse count value actually measured in the full open position P3.

Furthermore, as described above, the preset stop position P2 is offset from the full open position P3 by the predetermined distance on the fully closed position P0 side of the full open position P3. Thus, in the resetting process, the controller 31 subtracts the predetermined pulse count number Nos, which corresponds to the predetermined distance, from the pulse count value N_{P3} of the full open position P3 to obtain the corresponding pulse count value (N_{P3}-N_{OS}), which is then set as the pulse count value N_{P2} of the preset stop position P2.

Besides resetting the preset stop position P2, in the present embodiment, a value, which is obtained by subtracting a count value of a predetermined distance from the pulse count value N_{P3}, or a pulse count value at a predetermined distance from the fully closed position P0 is set as the pulse count value N_{P1} of the pinch sensing operation ceasing range P1 in the resetting operation.

Therefore, starting from the next operation, the window glass 11 will stop at the position where the pulse count value N reaches the newly set pulse count value N_{P2}. This position is offset from the locking position of the window glass 11 by the predetermined distance, so that the generation of the impact sound at the time of stopping the window glass 11 can be reliably limited.

Furthermore, according to the present embodiment, the pinching of the object is sensed in view of the pinch sensing operation ceasing position P1, which is reset, i.e., rearranged, so that the erroneous sensing of the pinching of the object can be advantageously limited.

In the above-described embodiment, the resetting process for resetting the preset stop position P2 is started when the operational switch 4 is placed in the automatic down position upon positioning of the window glass 11 in the preset stop position P2 and is held in the automatic down position for the predetermined time period (3 seconds in the above embodiment). However, the present invention is not limited to this. For example, the above embodiment may be modified as follows. That is, the resetting process may start when the operational switch 4 is placed in and is held in the down position for the predetermined time period.

Alternatively, the resetting process may be started when the operational switch 4 is placed in the automatic down position or the down position upon placement of the operational switch 4 in any position and is held in the automatic down position or the down position for a predetermined time period.

Furthermore, in the above embodiment, the panel member control system is implemented in the power window system 1 of the vehicle. However, the present invention is not limited to this. For instance, the panel member control system of the present invention may be alternatively implemented in any other system, in which a panel member is moved to open or close a corresponding opening, such as a sunroof panel opening and closing system, which drives a sunroof panel to open or close its associated opening, or a slide door panel opening and closing system, which drives a slide door panel to open or close its associated opening.

Additional advantages and modifications will readily occur to those skilled in the art. The invention in its broader terms is therefore not limited to the specific details, representative apparatus, and illustrative examples shown and described.

What is claimed is:

1. A panel member control system for controlling a panel member that is driven in an opening direction to open an opening of an opening defining member and is driven in a closing direction to close the opening of the opening defining member, the panel member control system comprising:
a driving means for driving the panel member;
a position sensing means for sensing a position of the panel member;
an operating means for outputting an operational command signal to drive the panel member through the driving means in the opening direction or the closing direction based on an operation performed by a user on the operating means; and
a controlling means for controlling the driving means based on both of the operation signal, which is received from the operating means, and the sensed position of the panel member, which is sensed by the position sensing means, wherein:
the controlling means normally stops the driving means to stop the panel member at a preset stop position, which is placed on an opening center side of an opening end locking position, in an opening operation of the panel member; and
the controlling means drives the driving means to move the panel member to the opening end locking position beyond the preset stop position and thereby to forcefully stop the panel member at the opening end locking position and resets the preset stop position based on an actual stop position of the panel member at the opening end locking position in a preset stop position resetting operation when the controlling means senses that the operating means is continuously operated by the user for a predetermined time period or longer to perform the opening operation of the panel member based on the operational command signal.

2. The panel member control system according to claim 1, wherein the controlling means drives the driving means to move the panel member to the opening end locking position when the controlling means senses that the operating means is continuously operated by the user for the predetermined time period or longer to perform the opening operation of the panel member based on the operational command signal in a state where the controlling means senses that the panel member is placed in the preset stop position.

3. The panel member control system according to claim 1, wherein the controlling means sets a position, which is spaced from the actual stop position of the panel member by a predetermined distance on an opening center side of the actual stop position of the panel member, as the preset stop position in the preset stop position resetting operation.

4. The panel member control system according to claim 1, wherein:
the operating means outputs a manual operational signal as the operational command signal in one operational state to drive the panel member through the driving means in the opening direction or the closing direction according to an operational time period of the operating means operated by the user;
the operating means outputs an automatic operational signal as the operational command signal in another operational state to automatically drive the panel member all the way to the preset stop position through the driving means; and
the controlling means performs the preset stop position resetting operation based on the automatic operational signal.

5. The panel member control system according to claim 1, wherein the controlling means resets the preset stop position in the preset stop position resetting operation after the controlling means resets the opening end locking position at the actual stop position of the panel member.

6. The panel member control system according to claim 1, further comprising a pinch sensing means for sensing pinching of an external object by the panel member in a closing operation of the panel member, wherein:
the pinch sensing means ceases the sensing of the pinching of the external object in a pinch sensing operation ceasing range, which is set from a closing end locking position on an opening center side of the closing end locking position;
the controlling means resets the pinch sensing operation ceasing range based on at least one of the actual stop position of the panel member at the opening end locking position and an actual stop position of the panel member at the closing end locking position; and
the controlling means obtains the actual stop position of the panel member at the closing end locking position when the controlling means drives the driving means to move the panel member to the closing end locking position and thereby to forcefully stop the panel member at the closing end locking position based on the operational command signal received from the operating means.

7. The panel member control system according to claim 1, wherein the panel member is a window glass of a vehicle door.
